(19) United States
(12) Patent Application Publication
(10) Pub. No.: US 2016/0066542 A1
(43) Pub. Date: Mar. 10, 2016

(54) QUICK SENSING PET NAIL CLIPPER DEVICE

(71) Applicant: Jennifer Kearns, Sigel, PA (US)

(72) Inventor: Jennifer Kearns, Sigel, PA (US)

(21) Appl. No.: 14/478,122

(22) Filed: Sep. 5, 2014

(51) Int. Cl. A01K 17/00; A45D 29/02

(52) U.S. Cl. CPC A01K 17/00; A45D 29/02

(57) ABSTRACT

A quick sensing pet nail clipper device for preventing cutting into a vein while clipping a pet's nails. The device includes a pliers having a first jaw, a second jaw, and a pair of handles. A heat sensor is coupled to the first one of the jaws wherein the heat sensor is configured for detecting a vein within a pet nail positioned adjacent to the first jaw. An alert is coupled to the pliers. The alert is operationally coupled to the heat sensor wherein the alert is actuated by the heat sensor.

### BACKGROUND OF THE DISCLOSURE

### Field of the Disclosure

The disclosure relates to pet nail clipping devices and more particularly pertains to a new pet nail clipping device for preventing cutting into a vein while clipping a pet's nails.

### SUMMARY OF THE DISCLOSURE

An embodiment of the disclosure meets the needs presented above by generally comprising a pliers having a first jaw, a second jaw, and a pair of handles. A heat sensor is coupled to the first one of the jaws wherein the heat sensor is configured for detecting a vein within a pet nail positioned adjacent to the first jaw. An alert is coupled to the pliers. The alert is operationally coupled to the heat sensor wherein the alert is actuated by the heat sensor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a quick sensing pet nail clipper device according to an embodiment of the disclosure.

FIG. 2 is a back view of an embodiment of the disclosure.

FIG. 3 is a side view of an embodiment of the disclosure.

FIG. 4 is a top view of an embodiment of the disclosure.

FIG. 5 is a bottom view of an embodiment of the disclosure.

### DESCRIPTION OF THE PREFERRED EMBODIMENT

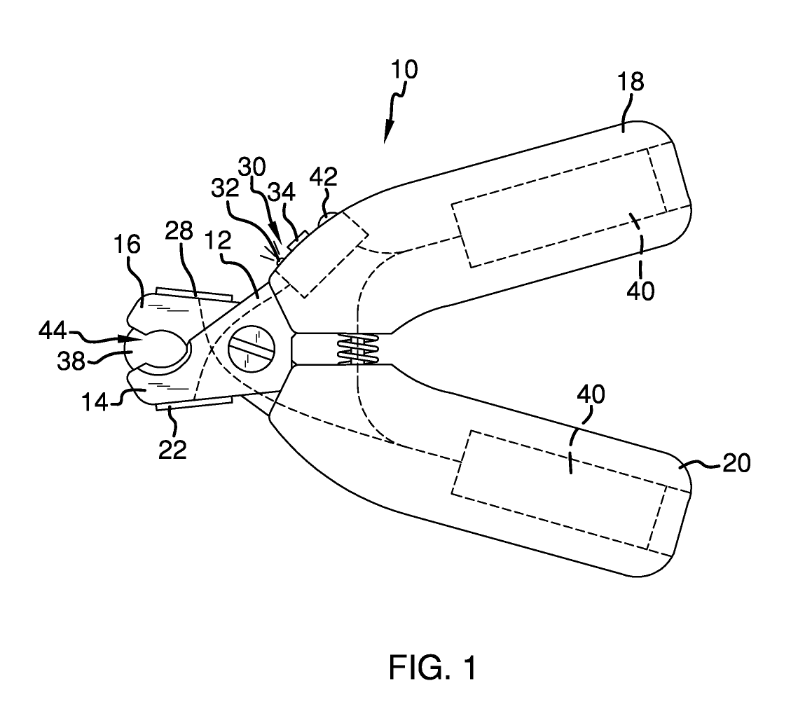

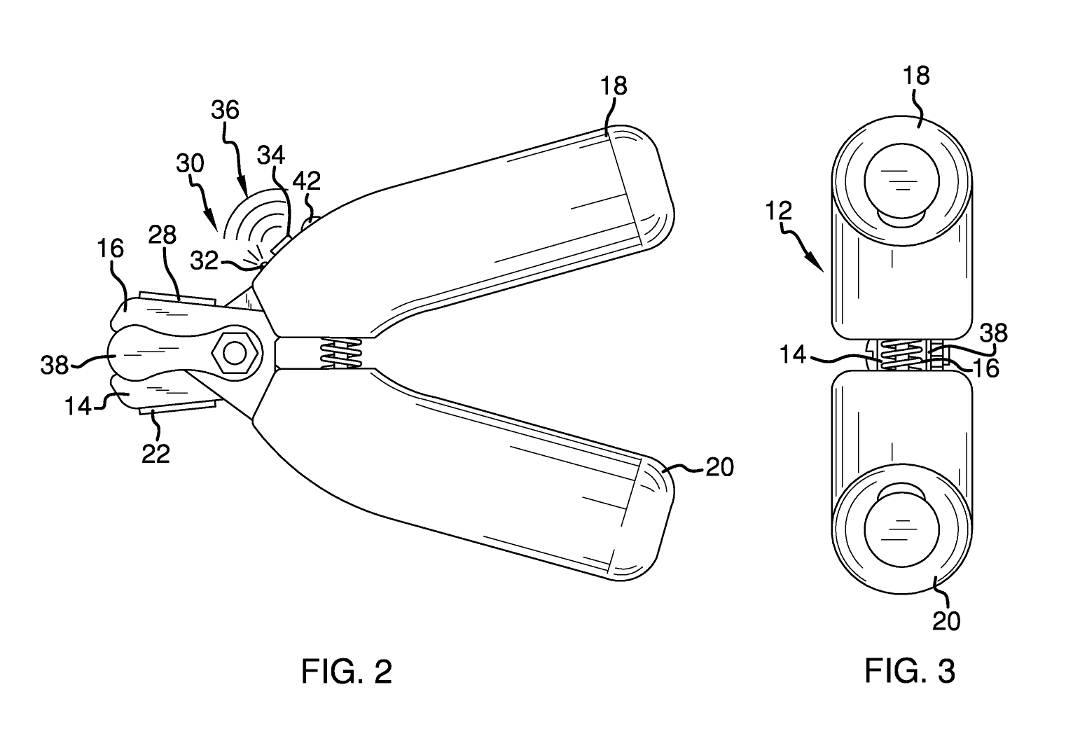

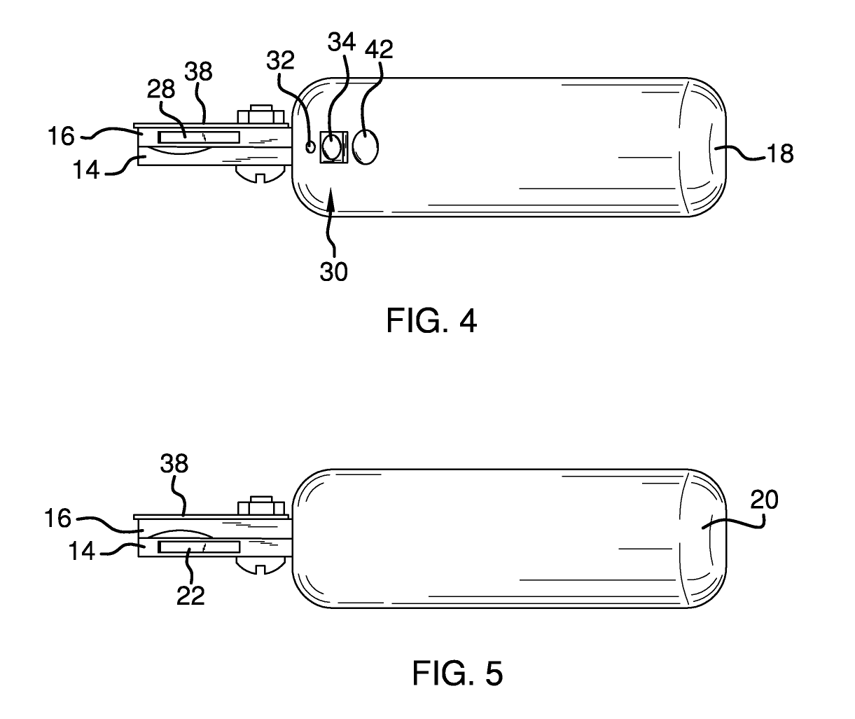

With reference now to the drawings, and in particular to FIGS. 1 through 5 thereof, a new pet nail clipping device embodying the principles and concepts of an embodiment of the disclosure and generally designated by the reference numeral 10 will be described.

As best illustrated in FIGS. 1 through 5, the quick sensing pet nail clipper device 10 generally comprises a pliers 12 having a first jaw 14, a second jaw 16, and a pair of handles 18,20. A first heat sensor 22 is coupled to the first jaw 14 wherein the first heat sensor 22 is configured for detecting a vein 24 within a pet nail 26 positioned adjacent to the first jaw 14. A second heat sensor 28 is coupled to the second jaw 16. Each of the first heat sensor 22 and the second heat sensor 28 are directed in a conventional manner to detect heat adjacent to the first jaw 14 and the second jaw 16. An alert 30 is coupled to the pliers 12 and operationally coupled to the first heat sensor 22 and second heat sensor 28 wherein the alert 30 is actuated by the first heat sensor 22 or the second heat sensor 28 detecting heat above a threshold level indicating a vein is present in the nail 26 positioned between the first jaw 14 and the second jaw 16. The alert 30 comprises a light 32 coupled to one of the handles 18,20. The light 32 is illuminated when the alert 30 is actuated. The alert 30 may alternatively or in combination comprise a speaker 34. The speaker 34 broadcasts an alarm sound 36 when the alert 30 is actuated.

A guard 38 is coupled to the pliers 12. The guard 38 is positioned adjacent to and parallel to the second jaw 16. The guard 38 provides a planar surface adjacent to space 44 between the first jaw 14 and the second jaw 16 where the pet nail 26 is cut by manipulation of the handles 18,20. Thus, the guard 38 obstructs and prevents the pet nail 26 from being trimmed more than a small amount with each use of the pliers 12.

A battery 40 is coupled to one of the handles 18,20. The battery 40 is electrically coupled to each of the first heat sensor 22, the second heat sensor 28 and the alert 30. The battery 40 may be one of two batteries 40 with each battery 40 being positioned in a respective one of the handles 18,20. A switch 42 is coupled to the one of the handles 18,20. The switch 42 is electrically coupled to the first heat sensor 22, the second heat sensor 28, the alert 30, and the battery 40 wherein the first heat sensor 22, the second heat sensor 28, and the alert 30 are powered by the battery 40 when the switch 42 is manipulated to an on position. The switch 42 may be a push button positioned adjacent to the light 32 and the speaker 34 on one of the handles 18,20.

In use, the switch 42 is manipulated to activate the first heat sensor 22 and the second heat sensor 28. The first jaw 14 and second jaw 16 are positioned on opposite sides of the pet nail 26 with an end of the pet nail 26 resting against the guard 38. If the vein 24 in the pet nail 26 is positioned too close to either the first jaw 14 or the second jaw 16, the vein 24 will be detected by either or both of the first heat sensor 22 and the second heat sensor 28 activating the alert 30. If the alert 30 is activated, a user knows not to clip the pet nail 26 as penetrating the vein 24 is too likely to occur. If the alert 30 is not activated, the user may clip the pet nail 26 by squeezing the pliers 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A quick sensing pet nail clipper device comprising:
a pliers having a first jaw, a second jaw, and a pair of handles;
a heat sensor being coupled to said first one of said jaws wherein said heat sensor is configured for detecting a vein within a pet nail positioned adjacent to said first jaw; and
an alert coupled to said pliers, said alert being operationally coupled to said heat sensor wherein said alert is actuated by said heat sensor.

2. The device of claim 1, further comprising:
said heat sensor being a first heat sensor; and
a second heat sensor, said second heat sensor being coupled to said second jaw, said alert being operationally coupled to said second heat sensor wherein said alert is actuated by said second heat sensor.

3. The device of claim 1, further comprising a guard being coupled to said pliers, said guard being positioned adjacent to and parallel to said second one of said jaws.

4. The device of claim 1, further comprising said alert comprising a light coupled to one of said handles, said light being illuminated when said alert is actuated.

5. The device of claim 1, further comprising said alert comprising a speaker, said speaker broadcasting an alarm sound upon when said alert is actuated.

6. The device of claim 1, further comprising a battery coupled to one of said handles, said battery being electrically coupled to each of said heat sensor and said alert.

7. The device of claim 6, further comprising a switch coupled to said one of said handles, said switch being electrically coupled to said heat sensor, said alert, and said battery wherein said heat sensor and said alert are powered by said battery when said switch is manipulated.

8. A quick sensing pet nail clipper device comprising:
a pliers having a first jaw, a second jaw, and a pair of handles;
a first heat sensor being coupled to said first one of said jaws wherein said first heat sensor is configured for detecting a vein within a pet nail positioned adjacent to said first jaw;
a second heat sensor, said second heat sensor being coupled to said second jaw wherein said second heat sensor is configured for detecting a vein within a pet nail positioned adjacent to said second jaw;
an alert coupled to said pliers, said alert being operationally coupled to said first heat sensor and said second heat sensor wherein said alert is actuated by either of said first heat sensor and said second heat sensor, said alert comprising a light coupled to one of said handles, said light being illuminated when said alert is actuated, said alert comprising a speaker, said speaker broadcasting an alarm sound upon when said alert is actuated;
a guard being coupled to said pliers, said guard being positioned adjacent to and parallel to said second one of said jaws;
a battery coupled to one of said handles, said battery being electrically coupled to each of said first heat sensor, said second heat sensor, and said alert; and
a switch coupled to said one of said handles, said switch being electrically coupled to said first heat sensor, said second heat sensor, said alert, and said battery wherein said first heat sensor, said second heat sensor, and said alert are powered by said battery when said switch is manipulated to an on position.
